(19) United States
(12) Patent Application Publication
(10) Pub. No.: US 2026/0278312 A1
(43) Pub. Date: Sep. 17, 2026

(54) COMMUNICATION SUPPORT SYSTEM USING SPEECH RECOGNITION TECHNOLOGY AND SPEECH SYNTHESIS TECHNOLOGY

(71) Applicant: SoftBank Group Corp., Tokyo (JP)

(72) Inventor: Kazuya TAMAOKI, Tokyo (JP)

(21) Appl. No.: 19/564,235

(22) Filed: Mar. 12, 2026

Related U.S. Application Data
(60) Provisional application No. 63/771,009, filed on Mar. 13, 2025.

(51) Int. Cl. G06F 40/58; G10L 13/033; G10L 15/19; G10L 21/0208

(52) U.S. Cl. CPC G06F 40/58; G10L 13/033; G10L 15/19; G10L 21/0208

(57) ABSTRACT

The present disclosure relates to a system that converts a user's voice into another language in real time and outputs it with a voice that maintains individuality. A voice input unit captures voice using a high-sensitivity microphone and removes noise with noise canceling technology. A speech recognition unit operates on the cloud and converts voice into text using an acoustic model and a language model. A translation unit translates text into another language using neural machine translation technology and considers context and cultural nuances. A speech synthesis unit selects a voice close to the user's voice quality from a voice database and generates a natural and unique voice. A voice output unit uses low-latency technology to transmit the synthesized voice to the user in real time.

### CROSS-REFERENCE TO RELATED APPLICATION

This application claims the benefit of priority from U.S. Provisional Patent Application No. 63/771,009, filed on Mar. 13, 2025. The entire contents of the priority application are incorporated herein by reference.

### BACKGROUND

The technology of the present disclosure relates to a system.

Japanese Unexamined Patent Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

The problem to be solved by this disclosure is to remove the language barrier in communication between people who speak different languages. Conventionally, for people who speak different languages to communicate smoothly, it was necessary to use an interpreter or a translation application. However, these methods have had the problem of lacking real-time performance and being unable to reflect the characteristics and individuality of individual voices.

Furthermore, in translation applications, text-based translation is mainstream, and it has been difficult to realize natural communication via voice. In particular, translation that considers prosody such as the intonation and rhythm of speech has been difficult, and as a result, mechanical and unnatural voice output has often occurred.

This disclosure solves these problems by converting a user's voice into another language in real time and outputting it with a voice quality close to the user's voice. This enables the user to have natural and smooth communication with people who speak different languages while maintaining their individuality. In addition, by using noise reduction technology and a voice sample selection algorithm, it is possible to improve the accuracy of speech recognition and realize more accurate translation and natural speech synthesis. This is expected to facilitate cross-cultural communication and promote global exchange.

As a means for solving the problem, the present disclosure provides a system including a voice input unit, a speech recognition unit, a translation unit, a speech synthesis unit, and a voice output unit. The voice input unit includes a microphone for capturing a user's voice with high sensitivity and converting it into a digital signal. This makes it possible to accurately acquire the user's voice and send it to the next processing stage.

The speech recognition unit analyzes the digital signal from the voice input unit and converts the voice into text data using an acoustic model and a language model. In this process, noise reduction technology is used to remove background noise and improve the accuracy of speech recognition. This accurately converts the user's utterance content into text and provides basic data for translation.

The translation unit includes a machine translation engine for translating the text data obtained from the speech recognition unit into another language. This engine utilizes a statistical translation model and a neural network to provide translation that considers context and cultural nuances. This enables accurate transmission of meaning between different languages.

The speech synthesis unit includes a voice database and a speech synthesis engine for converting the translated text data from the translation unit into voice. The voice database contains voice samples of various voice qualities, and selects a voice close to the user's voice quality. The speech synthesis engine adjusts prosody based on the selected voice sample to generate natural and unique voice.

The voice output unit includes earphones and low-latency audio streaming technology for transmitting the voice from the speech synthesis unit to the user in real time. This allows the user to instantly hear the translated voice, enabling smooth communication. In this way, the present disclosure realizes communication that transcends language barriers and promotes cross-cultural exchange.

### BRIEF DESCRIPTION OF DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example of a communication support method using speech recognition technology and speech synthesis technology.

### DETAILED DESCRIPTION

Hereinafter, an example of an embodiment of a system according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be A only, B only, or a combination of A and B. Also, in the present specification, when three or more matters are expressed by being connected with “and/or”, the same concept as “A and/or B” is applied.

### FIRST EMBODIMENT

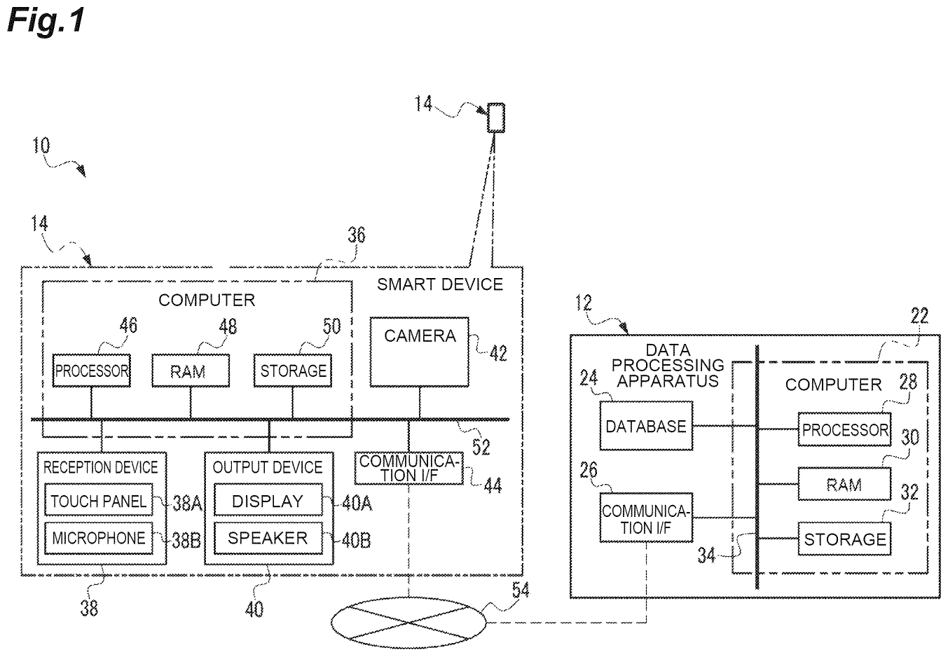

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a representation form (for example, voice and/or text) perceivable by the user 20. The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

Furthermore, the data processing apparatus 12 and the smart device 14 shown in FIG. 1 may adopt a distributed processing architecture. Specifically, the processor 46 of the smart device 14 includes a Neural Processing Unit (NPU) or a Digital Signal Processor (DSP), and executes initial feature extraction of voice input (for example, calculation of Mel-Frequency Cepstral Coefficients (MFCC) or conversion to a spectrogram) on the edge side (device side). On the other hand, the data processing apparatus 12 (server side) executes inference of a language model and speech synthesis processing, which have a higher computational load, based on the extracted feature quantities. With this distributed configuration, communication bandwidth is reduced by approximately 40% to 60% compared to the case of transmitting raw voice data, and by reducing communication latency, a real-time translation response within 200 milliseconds, which does not cause discomfort to humans, is realized.

In addition, the storages 32 and 50 include a high-speed cache memory having a ring buffer structure, and store a Packet Loss Concealment (PLC) algorithm that interpolates missing data from preceding and succeeding frames when packet loss occurs while absorbing jitter in voice streaming processing. This guarantees uninterrupted voice output even under an unstable network environment.

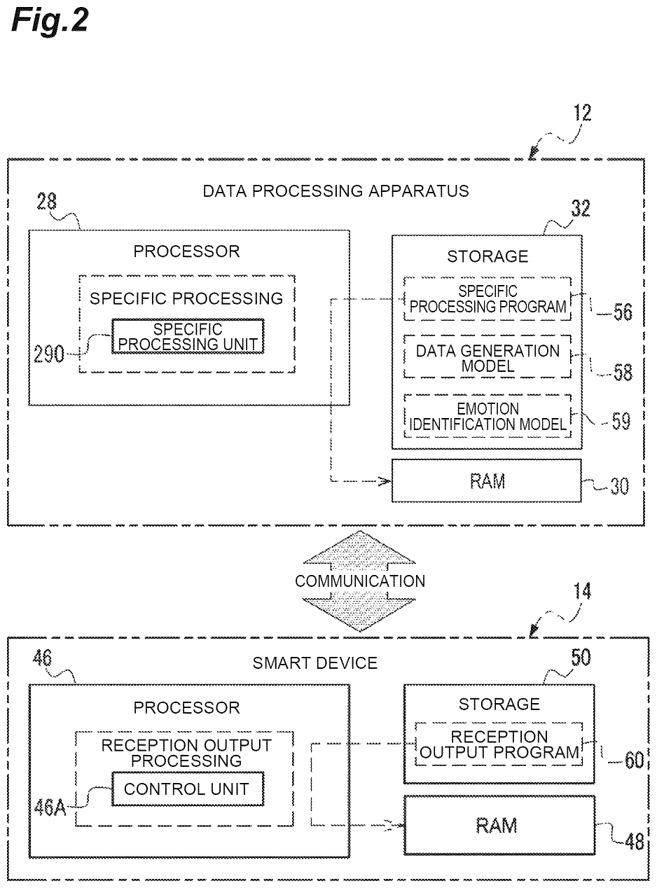

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the specific processing program 60 executed on the RAM 48. Note that the smart device 14 can also have a data generation model and an emotion identification model similar to the data generation model 58 and the emotion identification model 59, and perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### EXAMPLE 1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

A specific embodiment will be described in more detail. This system is realized by cooperation between a server and a terminal, and the functions of each unit are shared.

First, the voice input unit is mounted on a terminal. The voice input unit may be configured by, for example, the reception device 38. This terminal can be a smartphone, a tablet, a wearable device, or even a dedicated voice capture device. These terminals have a built-in high-sensitivity microphone and capture the user's voice with high accuracy. For example, by using noise canceling technology, it is possible to effectively remove ambient noise and acquire clear voice. Furthermore, the terminal has a function to adjust the sampling rate and bit depth of the voice, and optimizes the quality of the voice data.

Next, the speech recognition unit operates on the server. The speech recognition unit may be configured by, for example, the specific processing unit 290, the specific processing program 56, the data generation model 58, and the emotion identification model 59. This server is placed in a cloud computing environment and has a large data processing capability. The digital voice data transmitted from the terminal is analyzed on the server using a speech recognition engine equipped with an acoustic model and a language model. For example, the acoustic model utilizing deep learning technology analyzes the frequency characteristics of the voice in detail, and the language model converts the voice into text using grammar and vocabulary patterns. Thereby, the accuracy of speech recognition is improved, and the content of the user's utterance can be accurately converted into text. The acoustic model and the language model may be configured by the data generation model 58 and the emotion identification model 59.

The translation unit is also realized on the server. The translation unit may be configured by, for example, the specific processing unit 290, the specific processing program 56, the data generation model 58, and the emotion identification model 59. The text data obtained from the speech recognition unit is translated into another language by a machine translation engine in the server. For example, a translation engine using Neural Machine Translation (NMT) technology provides natural and accurate translation considering context and cultural nuances. The server supports dozens or more language pairs and can perform translation dynamically according to the user's selection. Furthermore, the translation engine has a function to learn the user's past translation history and provide translation optimized for each individual user.

The speech synthesis unit also operates on the server. The speech synthesis unit may be configured by, for example, the specific processing unit 290, the specific processing program 56, the data generation model 58, and the emotion identification model 59. The translated text data is converted into voice by a speech synthesis engine in the server. For example, the voice database stores voice samples of hundreds of types of voice qualities, and an algorithm for selecting a voice close to the user's voice quality is implemented. The speech synthesis engine adjusts prosody (intonation and rhythm) based on the selected voice sample to generate a natural and unique voice. Thereby, the synthesized voice reflects the user's individuality and gives a natural impression to the listener.

The “algorithm for selecting a voice close to the user's voice quality” in the speech synthesis unit will be described in detail. In this embodiment, a speaker-adaptive Text-to-Speech (TTS) system is adopted. Specifically, an encoder is used to extract a fixed-dimensional vector representing the speaker's voice quality characteristics (a speaker embedding vector such as a d-vector or x-vector) from the user's voice captured by the voice input unit. This speaker embedding vector is input to the speech synthesis engine (for example, one based on an architecture such as Tacotron 2 or FastSpeech) together with the translated text data. By using this vector as a conditioning input, the speech synthesis engine generates a waveform that reproduces the user's unique tone, pitch, and speaking style even in the target language. This processing is realized by arithmetic processing in a high-dimensional vector space, which is impossible to reproduce by human mental processes.

Furthermore, in the adjustment of prosody, the system has a conversion model that extracts the trajectory of the fundamental frequency (F0) and the energy contour of the input voice and normalizes them according to the prosodic rules of the target language. Thereby, it becomes possible not only to imitate the voice quality but also to transfer non-verbal information such as “urgency” or “calmness” possessed by the input voice to the translated voice.

Finally, the voice output unit is realized by the terminal. The voice output unit may be configured by, for example, the output device 40. The synthesized voice transmitted from the server is transmitted to the user in real time through the earphones of the terminal. For example, by using low-latency audio streaming technology, the delay of the voice is minimized, and smooth communication is realized. Thereby, the user can immediately hear the translated voice, enabling smooth dialogue with people who speak different languages.

In this way, the present disclosure realizes communication that transcends language barriers and promotes cross-cultural exchange through the cooperative operation of the server and the terminal. By sharing the functions of each unit, the efficiency of the entire system is improved, and it is possible to provide a user-friendly interface.

### (System Configuration)

The system according to the present embodiment includes a voice input unit, a speech recognition unit, a translation unit, a speech synthesis unit, and a voice output unit. The voice input unit includes a microphone for capturing a user's voice with high accuracy. Specifically, a high-sensitivity microphone built into a smartphone, a tablet, a wearable device, or the like is used. This makes it possible to clearly acquire the user's utterance. Furthermore, it is provided with noise canceling technology, and improves the quality of voice data by effectively removing ambient noise. It also has a function to adjust the sampling rate and bit depth of the voice, and optimizes the efficiency of digital signal processing.

The speech recognition unit operates on a server and analyzes the digital voice data transmitted from the voice input unit. Specifically, a server placed in a cloud computing environment utilizes a large amount of data processing capacity to convert voice into text. High-precision speech recognition is realized by using an acoustic model and a language model to analyze the frequency characteristics of the voice in detail and to analyze grammar and vocabulary patterns. For example, a model utilizing deep learning technology improves the accuracy of speech recognition. It also holds speech recognition models corresponding to a plurality of languages, and can use an appropriate model according to the user's selection.

The translation unit uses a machine translation engine in the server to translate the text data obtained from the speech recognition unit into another language. Specifically, an engine using neural machine translation technology provides natural and accurate translation, considering context and cultural nuances. The server supports several tens or more of language pairs and can perform translation dynamically according to the user's needs. Furthermore, the translation engine has a function to learn the user's past translation history and provide translation optimized for each individual user. For example, it also has a customization function to preferentially translate specific technical terms or phrases.

The speech synthesis unit uses a speech synthesis engine in the server to convert the translated text data into voice. Specifically, several hundred types of voice quality voice samples are stored in a voice database, and an algorithm for selecting a voice close to the user's voice quality is implemented. The speech synthesis engine adjusts prosody based on the selected voice sample to generate natural and unique voice. This allows the synthesized voice to reflect the user's individuality and give a natural impression to the listener. For example, by imitating the tone and rhythm of the user's voice, it is possible to provide a more familiar voice.

The voice output unit transmits the synthesized voice transmitted from the server to the user in real time through the terminal's earphones. Specifically, by using low-latency audio streaming technology, the delay of the voice is minimized, and smooth communication is realized. This allows the user to instantly hear the translated voice, enabling smooth dialogue with people who speak different languages. For example, by using wireless earphones utilizing a Bluetooth connection, the user's convenience can be improved.

Specific examples of prompt sentences to be read into the generative AI necessary for carrying out the present disclosure include “Please explain how to capture a user's voice with high accuracy, remove noise, and acquire clear voice data” and “Please describe in detail the design of an acoustic model and a language model for improving the accuracy of speech recognition”. This makes it possible to understand in detail how each part of the system functions and how they operate in cooperation.

### (Implementation Steps)

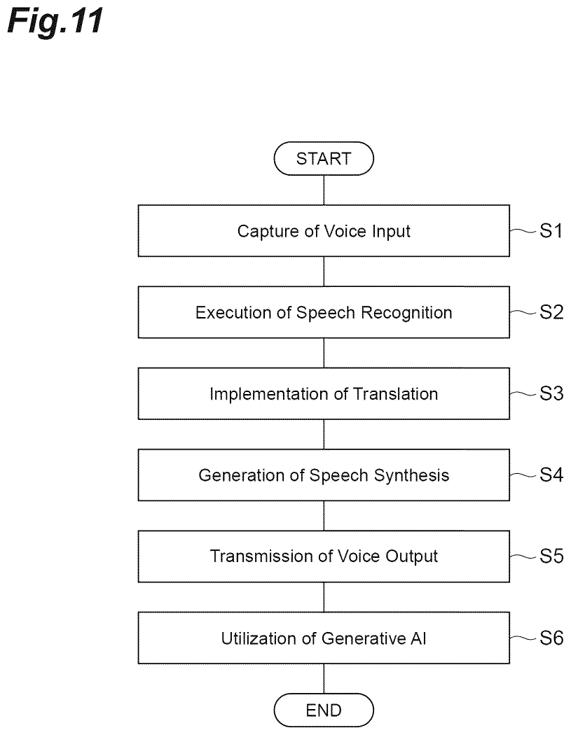

### Step 1: Capture of Voice Input (See Step S1 in FIG. 11)

When a user starts speaking, a high-sensitivity microphone mounted on a terminal captures the voice. This microphone is built into a smartphone, a tablet, or a wearable device, and removes ambient noise using noise canceling technology. This acquires clear voice data, which is then transmitted to the next processing step. The sampling rate and bit depth of the voice are adjusted to optimize the efficiency of digital signal processing.

### Step 2: Execution of Speech Recognition (See Step S2 in FIG. 11)

The digital voice data transmitted from the voice input unit is sent to a speech recognition unit that operates on a server. Here, a cloud computing environment is used to utilize a large amount of data processing capacity and convert voice into text. High-precision speech recognition is realized by using an acoustic model and a language model to analyze the frequency characteristics of the voice in detail and to analyze grammar and vocabulary patterns. A model utilizing deep learning technology improves the accuracy of speech recognition.

### Step 3: Implementation of Translation (See Step S3 in FIG. 11)

The text data obtained from the speech recognition unit is translated into another language by a machine translation engine in the server. An engine using neural machine translation technology provides natural and accurate translation, considering context and cultural nuances. The server supports several tens or more of language pairs and can perform translation dynamically according to the user's needs. The translation engine has a function to learn the user's past translation history and provide translation optimized for each individual user.

### Step 4: Generation of Speech Synthesis (See Step S4 in FIG. 11)

The translated text data is converted into voice by a speech synthesis engine in the server. Several hundred types of voice quality voice samples are stored in a voice database, and an algorithm for selecting a voice close to the user's voice quality is implemented. The speech synthesis engine adjusts prosody based on the selected voice sample to generate natural and unique voice. This allows the synthesized voice to reflect the user's individuality and give a natural impression to the listener.

### Step 5: Transmission of Voice Output (See Step S5 in FIG. 11)

The synthesized voice transmitted from the server is transmitted to the user in real time through the terminal's earphones. By using low-latency audio streaming technology, the delay of the voice is minimized, and smooth communication is realized. This allows the user to instantly hear the translated voice, enabling smooth dialogue with people who speak different languages.

### Step 6: Utilization of Generative AI (See Step S6 in FIG. 11)

In the step of using generative AI, optimization and learning of AI models are performed in each process of speech recognition, translation, and speech synthesis. Specific examples of prompt sentences include “Please explain how to capture a user's voice with high accuracy, remove noise, and acquire clear voice data” and “Please describe in detail the design of an acoustic model and a language model for improving the accuracy of speech recognition”. This makes it possible to understand in detail how each part of the system functions and how they operate in cooperation.

### (Specific Use Case)

For example, consider a case where a business person participating in an international conference uses the present disclosure to communicate smoothly with participants who speak different languages. This business person installs the system of the present disclosure on a smartphone and uses it during the conference. The voice input unit captures the business person's utterance with a high-sensitivity microphone and removes ambient noise using noise canceling technology. This acquires clear voice data.

The speech recognition unit operates on a server placed in a cloud computing environment and converts the voice into text. High-precision speech recognition is realized by using an acoustic model and a language model to analyze the frequency characteristics of the voice in detail and to analyze grammar and vocabulary patterns. This accurately converts the business person's utterance content into text.

The translation unit translates the text data obtained from the speech recognition unit into another language. An engine using neural machine translation technology provides natural and accurate translation, considering context and cultural nuances. The server supports several tens or more of language pairs and can perform translation dynamically according to the business person's needs.

The speech synthesis unit converts the translated text data into voice. Several hundred types of voice quality voice samples are stored in a voice database, and an algorithm for selecting a voice close to the business person's voice quality is implemented. The speech synthesis engine adjusts prosody based on the selected voice sample to generate natural and unique voice.

The voice output unit transmits the synthesized voice transmitted from the server to the business person in real time through the smartphone's earphones. By using low-latency audio streaming technology, the delay of the voice is minimized, and smooth communication is realized. This allows the business person to instantly hear the translated voice, enabling smooth dialogue with participants who speak different languages.

Specific examples of prompt sentences to be read into the generative AI include “Please detail the process of speech recognition and translation for facilitating communication between different languages in an international conference” and “Please explain the detailed design of speech synthesis technology used by a business person during a conference”. This makes it possible to understand in detail how the system functions and how it meets the user's needs.

### APPLICATION EXAMPLE 1

A flow of specific processing in Application Example 1 will be described. Each unit of the system described below is realized by the data processing apparatus 12 and the smart device 14. Also, the data processing apparatus 12 is referred to as a “server”, and the smart device 14 is referred to as a “terminal”.

### EMBODIMENT

An embodiment will be described more specifically and in detail. This system is designed to realize multilingual communication in a nursing care facility, and includes a voice input unit, a speech recognition unit, a translation unit, a speech synthesis unit, and a voice output unit.

The voice input unit captures the utterances of care staff using high-sensitivity microphones installed in each room and common space within the facility. For example, a microphone installed in a resident's room can clearly pick up voice even when the user is lying in bed. This eliminates the need for care staff to raise their voices when giving instructions to the elderly, enabling natural conversation. In addition, a microphone installed in a common space can identify and capture a specific voice even when multiple people are conversing at the same time. By using noise canceling technology, background noise such as the sound of a television or other conversations is effectively removed to acquire clear voice data. Furthermore, the voice input unit has a function to adjust the sampling rate and bit depth of the voice, and optimizes the efficiency of digital signal processing.

The speech recognition unit operates on a server placed in a cloud computing environment. The digital voice data transmitted from the voice input unit is analyzed using an acoustic model and a language model and converted into text data. For example, an acoustic model utilizing deep learning technology analyzes the frequency characteristics of the voice in detail, and a language model converts the voice into text using grammar and vocabulary patterns. This improves the accuracy of speech recognition, and the utterance content of the care staff is accurately converted into text. Furthermore, by pre-learning technical terms used by care staff and frequently used phrases within the facility, the recognition accuracy can be improved. For example, by pre-learning voice data including medical terms and care-specific instruction words, misrecognition is reduced.

The translation unit translates the text data obtained from the speech recognition unit into another language according to the native languages of the care staff and the elderly. A translation engine using a neural network provides natural and accurate translation, considering context and cultural nuances. For example, when a Japanese-speaking staff member gives an instruction to an English-speaking elderly person, the Japanese text is translated into English. The server supports several tens or more of language pairs and can perform translation dynamically according to the user's needs. Furthermore, the translation engine has a function to learn the user's past translation history and provide translation optimized for each individual user. This makes it possible to use more familiar expressions for specific elderly people.

The speech synthesis unit converts the translated text data into voice. A voice database stores voice samples of various voice qualities, and an algorithm for selecting a voice close to the voice quality of the elderly is implemented. This makes the synthesized voice natural and familiar. For example, the voice can be generated at a slow pace so that it is easy for the elderly to hear. In addition, by adjusting the intonation and rhythm of the voice, it is possible to reproduce a more natural conversation.

The voice output unit transmits the synthesized voice to the elderly in real time through speakers in the facility. By using low-latency audio streaming technology, the delay of the voice is minimized, and smooth communication is realized. For example, speakers are installed in the rooms and common spaces of the elderly so that they can hear the voice wherever they are. This eliminates the need for care staff to be face-to-face when giving instructions to the elderly, enabling efficient care.

In this way, the present disclosure can realize smooth communication between care staff and elderly people who speak different languages in a nursing care facility, and perform individual care more effectively. This is expected to improve the quality of care and the quality of life of the elderly. Furthermore, by having each part of the system operate in cooperation, the operational efficiency of the entire facility is also improved, contributing to a reduction in the burden on staff.

### (System Configuration)

The system according to the present embodiment includes a voice input unit, a speech recognition unit, a translation unit, a speech synthesis unit, and a voice output unit. The voice input unit captures the utterances of care staff using high-sensitivity microphones installed in the nursing care facility. For example, a microphone installed in a resident's room can clearly pick up voice even when the user is lying in bed. This eliminates the need for care staff to raise their voices when giving instructions to the elderly, enabling natural conversation. In addition, a microphone installed in a common space can identify and capture a specific voice even when multiple people are conversing at the same time. By using noise canceling technology, background noise such as the sound of a television or other conversations is effectively removed to acquire clear voice data. Furthermore, the voice input unit has a function to adjust the sampling rate and bit depth of the voice, and optimizes the efficiency of digital signal processing.

The speech recognition unit operates on a server placed in a cloud computing environment. The digital voice data transmitted from the voice input unit is analyzed using an acoustic model and a language model and converted into text data. For example, an acoustic model utilizing deep learning technology analyzes the frequency characteristics of the voice in detail, and a language model converts the voice into text using grammar and vocabulary patterns. This improves the accuracy of speech recognition, and the utterance content of the care staff is accurately converted into text. Furthermore, by pre-learning technical terms used by care staff and frequently used phrases within the facility, the recognition accuracy can be improved. For example, by pre-learning voice data including medical terms and care-specific instruction words, misrecognition is reduced.

The translation unit translates the text data obtained from the speech recognition unit into another language according to the native languages of the care staff and the elderly. A translation engine using a neural network provides natural and accurate translation, considering context and cultural nuances. For example, when a Japanese-speaking staff member gives an instruction to an English-speaking elderly person, the Japanese text is translated into English. The server supports several tens or more of language pairs and can perform translation dynamically according to the user's needs. Furthermore, the translation engine has a function to learn the user's past translation history and provide translation optimized for each individual user. This makes it possible to use more familiar expressions for specific elderly people.

The speech synthesis unit converts the translated text data into voice. A voice database stores voice samples of various voice qualities, and an algorithm for selecting a voice close to the voice quality of the elderly is implemented. This makes the synthesized voice natural and familiar. For example, the voice can be generated at a slow pace so that it is easy for the elderly to hear. In addition, by adjusting the intonation and rhythm of the voice, it is possible to reproduce a more natural conversation.

The voice output unit transmits the synthesized voice to the elderly in real time through speakers in the facility. By using low-latency audio streaming technology, the delay of the voice is minimized, and smooth communication is realized. For example, speakers are installed in the rooms and common spaces of the elderly so that they can hear the voice wherever they are. This eliminates the need for care staff to be face-to-face when giving instructions to the elderly, enabling efficient care.

Specific examples of prompt sentences to be read into the generative AI necessary for carrying out the present disclosure include “Please detail the design of a multilingual communication system in a nursing care facility” and “Please explain the process of speech recognition and translation between care staff and elderly people who speak different languages”. This makes it possible to understand in detail how each part of the system functions and how they operate in cooperation.

### (Implementation Steps)

### Step 1: Capture of Voice Input

When a care staff member gives an instruction or asks a question to an elderly person, the voice is captured by a high-sensitivity microphone installed in the facility. This microphone is installed in rooms and common spaces, and can clearly pick up voice regardless of the user's situation. By using noise canceling technology, background noise such as the sound of a television or other conversations is removed to acquire clear voice data. The sampling rate and bit depth of the voice are adjusted to optimize the efficiency of digital signal processing.

### Step 2: Execution of Speech Recognition

The digital voice data transmitted from the voice input unit is sent to a speech recognition unit that operates on a server placed in a cloud computing environment. High-precision speech recognition is realized by using an acoustic model and a language model to analyze the frequency characteristics of the voice in detail and to analyze grammar and vocabulary patterns. The recognition accuracy is improved by pre-learning technical terms used by care staff and frequently used phrases within the facility.

### Step 3: Implementation of Translation

The text data obtained from the speech recognition unit is translated into another language by the translation unit according to the native languages of the care staff and the elderly. A translation engine using a neural network provides natural and accurate translation, considering context and cultural nuances. The server supports several tens or more of language pairs and can perform translation dynamically according to the user's needs.

### Step 4: Generation of Speech Synthesis

The translated text data is converted into voice by the speech synthesis unit. A voice database stores voice samples of various voice qualities, and an algorithm for selecting a voice close to the voice quality of the elderly is implemented. This makes the synthesized voice natural and familiar. By adjusting the intonation and rhythm of the voice, it is possible to reproduce a more natural conversation.

### Step 5: Transmission of Voice Output

The synthesized voice is transmitted to the elderly in real time through speakers in the facility by the voice output unit. By using low-latency audio streaming technology, the delay of the voice is minimized, and smooth communication is realized. Speakers are installed in the rooms and common spaces of the elderly so that they can hear the voice wherever they are.

### Step 6: Utilization of Generative AI

In the step of using generative AI, optimization and learning of AI models are performed in each process of speech recognition, translation, and speech synthesis. Specific examples of prompt sentences include “Please detail the design of a multilingual communication system in a nursing care facility” and “Please explain the process of speech recognition and translation between care staff and elderly people who speak different languages”. This makes it possible to understand in detail how each part of the system functions and how they operate in cooperation.

### (Specific Use Case)

For example, consider a situation in a nursing care facility where a Japanese-speaking care staff member provides daily care to an English-speaking elderly person. This system is used to realize smooth communication by transcending the language barrier when the care staff gives instructions to the elderly person.

When the care staff speaks to the elderly person in Japanese, saying “It's time for your medicine,” the voice is captured by a high-sensitivity microphone installed in the facility. By using noise canceling technology, background noise is removed to acquire clear voice data. This voice data is transmitted to a server placed in a cloud computing environment and converted into text data by a speech recognition unit. By using an acoustic model and a language model, the frequency characteristics of the voice are analyzed in detail to realize accurate text conversion.

Next, the text data obtained from the speech recognition unit is translated into English by the translation unit. A translation engine using a neural network provides natural and accurate translation, considering context and cultural nuances. The translated text data is converted into voice by the speech synthesis unit. A voice database stores voice samples of various voice qualities, and an algorithm for selecting a voice close to the voice quality of the elderly is implemented. This makes the synthesized voice natural and familiar.

The synthesized voice is transmitted to the elderly in real time through speakers in the facility by the voice output unit. By using low-latency audio streaming technology, the delay of the voice is minimized, and smooth communication is realized. The elderly person can understand the care staff's instructions and respond appropriately by listening to the English voice coming from the speaker.

In this way, the present disclosure can realize smooth communication between care staff and elderly people who speak different languages in a nursing care facility, and perform individual care more effectively. This is expected to improve the quality of care and the quality of life of the elderly.

Specific examples of prompt sentences to be read into the generative AI include “Please detail the design of a multilingual communication system in a nursing care facility” and “Please explain the process of speech recognition and translation between care staff and elderly people who speak different languages”. This makes it possible to understand in detail how each part of the system functions and how they operate in cooperation.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

As a specific method of natural language processing in the data generation model 58, an Attention mechanism (self-attention mechanism) using a Transformer architecture is applied. This model calculates the dependency between each word of the input text data in parallel regardless of the length of the sentence, and performs translation and sentiment analysis while maintaining context. In particular, in this system, a “Distilled Model” in which model weight parameters are lightened by Quantization and Pruning may be used so that it can operate even on an edge device (smart device 14) with limited computational resources. Thereby, it becomes possible to provide minimum translation and danger detection functions even in an offline environment where server communication is interrupted.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart device 14.

### SECOND EMBODIMENT

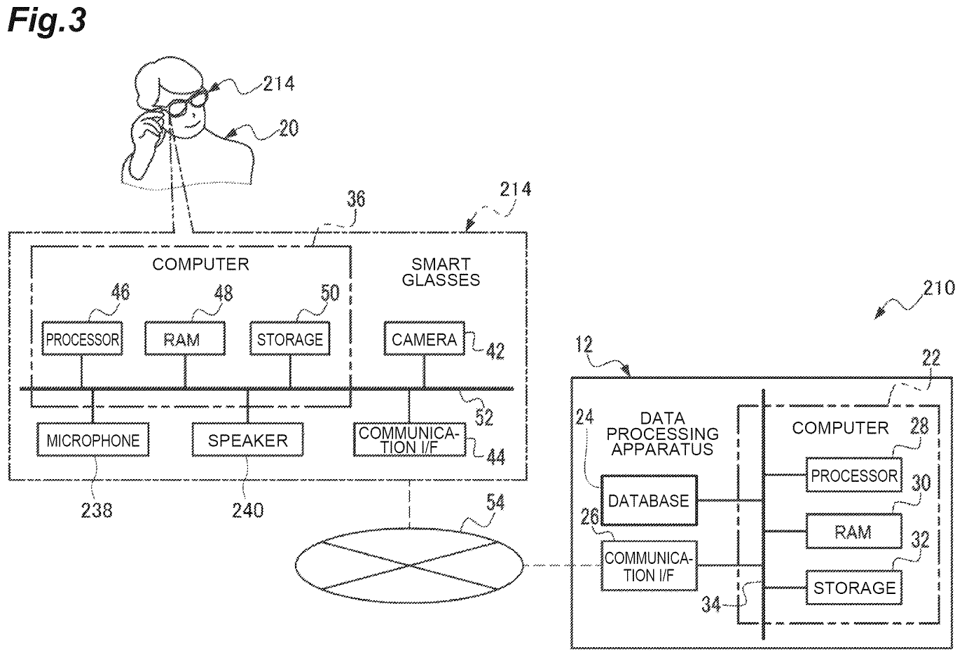

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

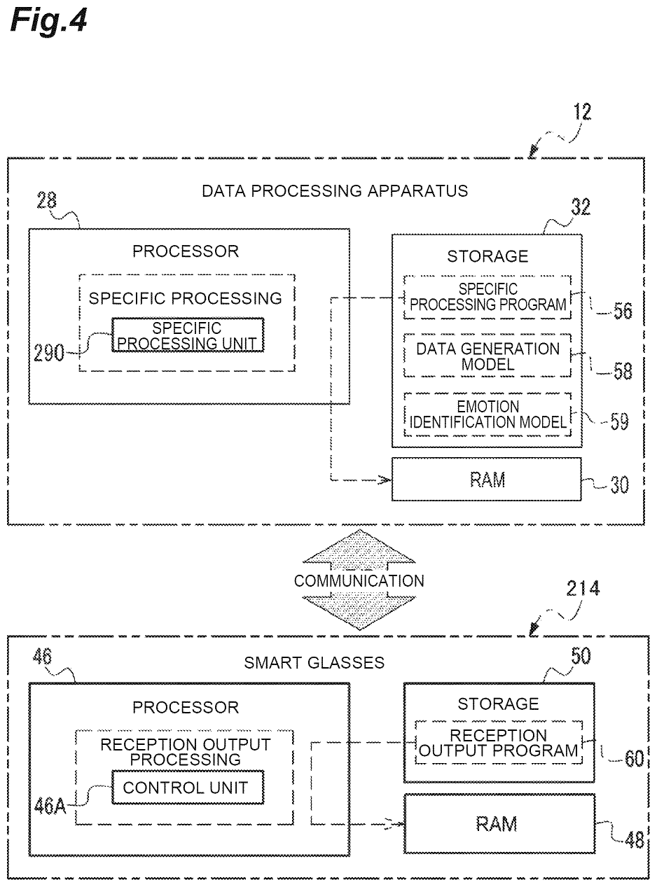

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but the present disclosure is not limited to such an example. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 can also have a data generation model and an emotion identification model similar to the data generation model 58 and the emotion identification model 59, and perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### EXAMPLE 1

Since the flow of the specific processing is the same as that in Example 1 described in the first embodiment, a description thereof is omitted.

### APPLICATION EXAMPLE 1

Since the flow of the specific processing is the same as that in Example 1 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the smart glasses 214.

### THIRD EMBODIMENT

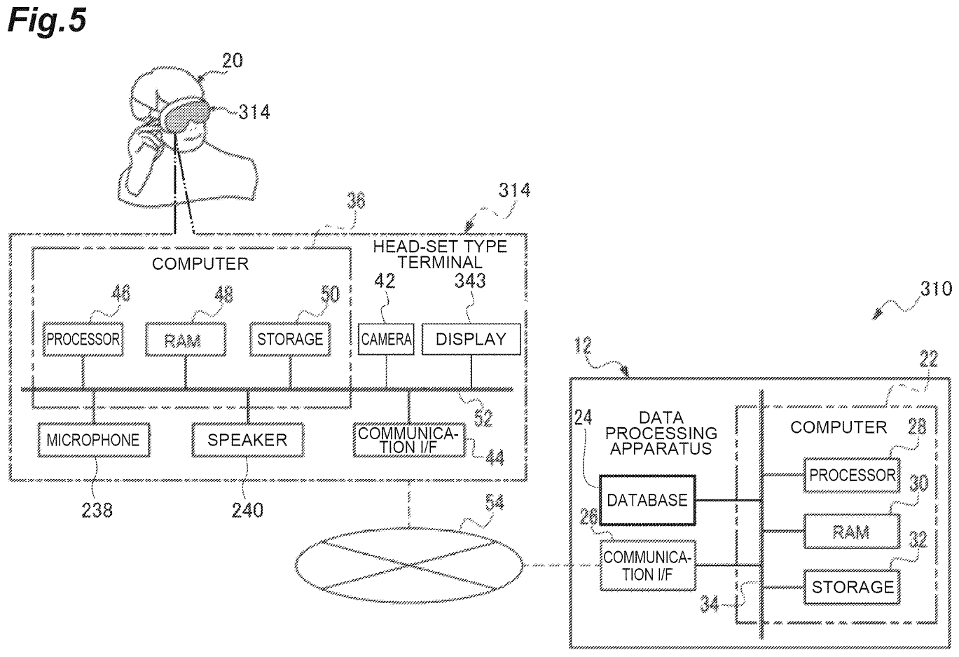

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

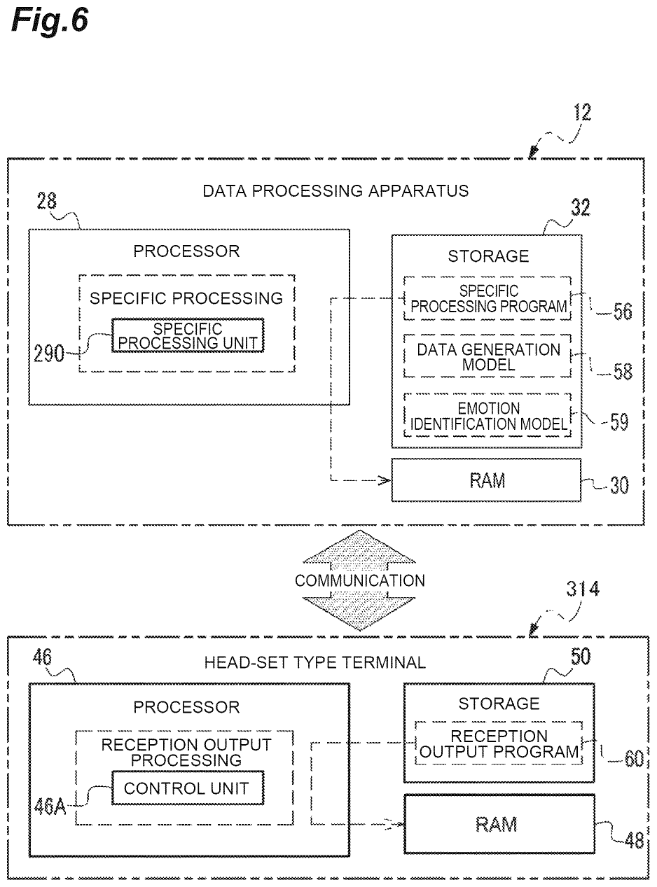

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### EXAMPLE 1

Since the flow of the specific processing is the same as that in Example 1 described in the first embodiment, a description thereof is omitted.

### APPLICATION EXAMPLE 1

Since the flow of the specific processing is the same as that in Example 1 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the headset-type terminal 314.

### FOURTH EMBODIMENT

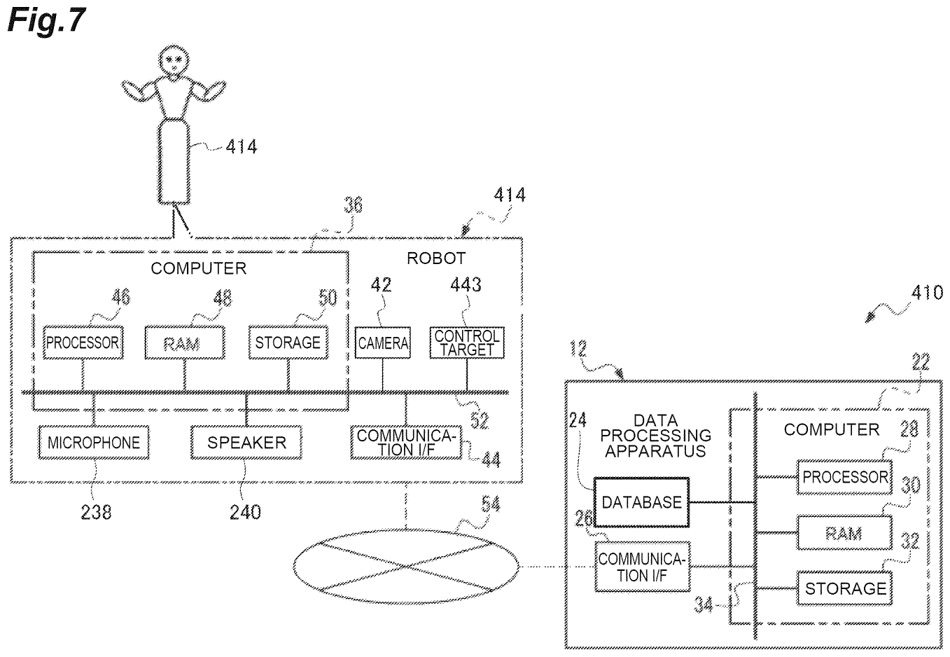

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

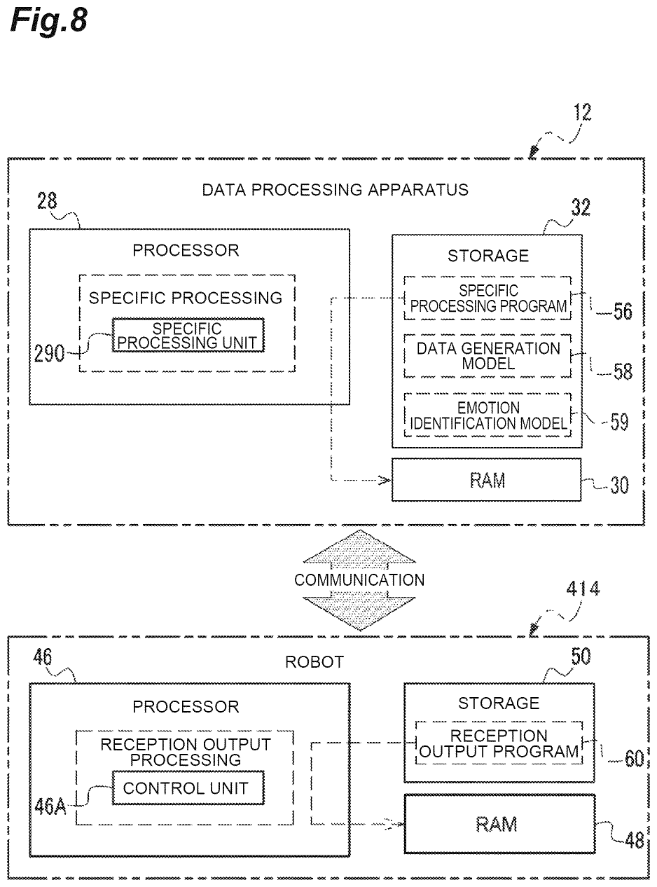

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48.

The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### EXAMPLE 1

Since the flow of the specific processing is the same as that in Example 1 described in the first embodiment, a description thereof is omitted.

### APPLICATION EXAMPLE 1

Since the flow of the specific processing is the same as that in Example 1 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but the present disclosure is not limited to such examples. Also, the AI may be an AI agent. Also, when the processing of each unit described above is performed by an AI, the processing is partially or entirely performed by the AI, but the present disclosure is not limited to such an example. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

In the above embodiment, an example form in which the specific processing is performed by the data processing apparatus 12 has been described, but the technology of the present disclosure is not limited to this, and the specific processing may be performed by the robot 414.

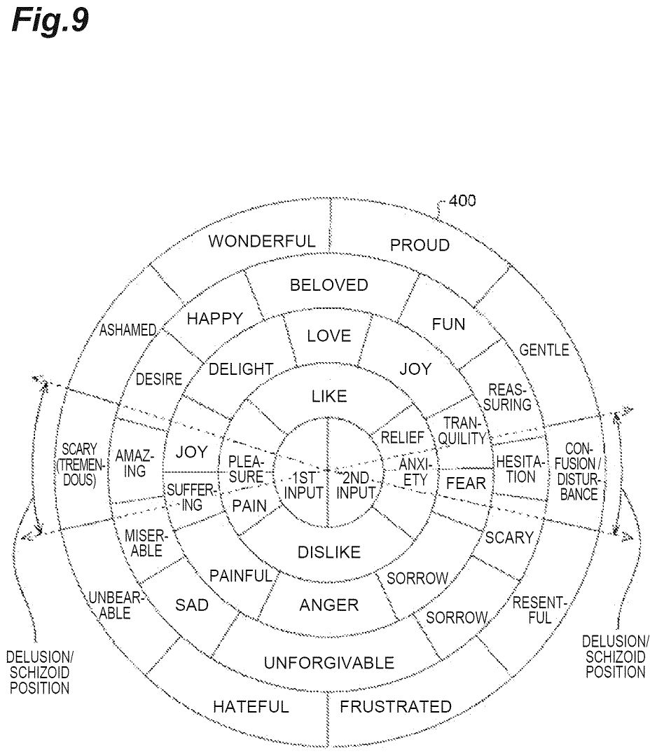

Note that the emotion identification model 59 as an emotion engine may determine a user's emotion according to a specific mapping. Specifically, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

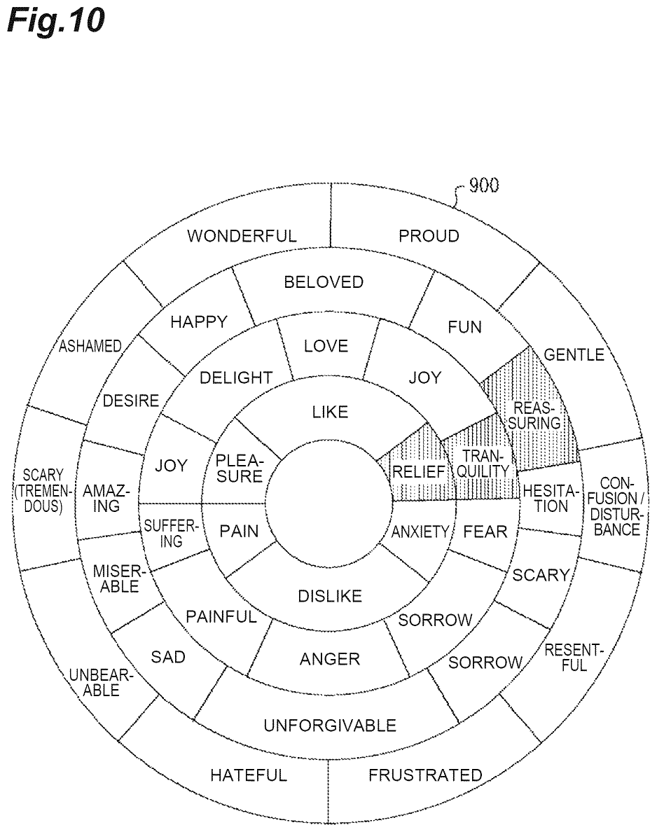

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

In the above embodiment, an example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

In the above embodiment, an example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, more specifically, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

Regarding the above embodiments, the following is further disclosed.

### APPLICATION EXAMPLE 1

A system comprising a voice input unit, a speech recognition unit, a translation unit, a speech synthesis unit, and a voice output unit. The voice input unit captures utterances of care staff using a high-sensitivity microphone installed in a nursing care facility and removes background noise using noise canceling technology. The speech recognition unit operates on a server placed in a cloud computing environment and converts voice into text using an acoustic model and a language model. The translation unit uses a neural network to translate text data obtained from the speech recognition unit into another language according to the native languages of the care staff and the elderly. The speech synthesis unit converts the translated text data into voice and selects a voice close to the voice quality of the elderly from a voice database. The voice output unit uses low-latency audio streaming technology to transmit the synthesized voice to the elderly in real time through a speaker in the facility.

The system, wherein the voice input unit includes microphones placed in each room and common space within the facility, and is designed to be able to pick up voice wherever the care staff is. The speech recognition unit has a function to improve recognition accuracy by pre-learning technical terms used by care staff and frequently used phrases within the facility. The translation unit supports several tens or more of language pairs and can perform translation dynamically according to the user's needs.

The system, wherein the speech synthesis unit has a function to generate voice at a slow pace so that it is easy for the elderly to hear, using several hundred types of voice quality voice samples stored in a voice database. The voice output unit installs speakers in the rooms and common spaces of the elderly so that they can hear the voice wherever they are. Thereby, communication between care staff and the elderly is facilitated, and it is expected that individual care will be performed more effectively.

A communication support system comprising: a voice input device, a circuitry, an acoustic model, a language model, a speech recognition engine, a machine translation engine, a speech synthesis engine, and a voice output device, wherein the voice input device converts voice from a user into a digital signal, wherein the circuitry is configured to: analyze the digital signal using the speech recognition engine equipped with the acoustic model and the language model to convert it into text data; translate the text data into a different language using the machine translation engine; and convert the translated text data into voice using the speech synthesis engine, and wherein the voice output device outputs the voice to the user in real time.

The communication support system, wherein the circuitry is configured to remove background noise based on noise reduction technology.

The communication support system, further comprising a voice database, wherein the circuitry is configured to: select one of a number of voice samples stored in the voice database as the voice based on a voice sample selection algorithm; and voice profiling; and generate the voice adjusted to the user's prosody using the speech synthesis engine.

The communication support system, wherein the circuitry is configured to translate the text data using context and cultural nuance as parameters using a statistical translation model and a neural network.

A communication support method using a communication support system, wherein the communication support system comprises a voice input device, an acoustic model, a language model, a speech recognition engine, a machine translation engine, a speech synthesis engine, and a voice output device, the method comprising: converting voice from a user into a digital signal by the voice input device; analyzing the digital signal using the speech recognition engine equipped with the acoustic model and the language model to convert it into text data; translating the text data into a different language using the machine translation engine; converting the translated text data into voice using the speech synthesis engine; and outputting the voice to the user in real time by the voice output device.

1. A communication support system comprising:
a voice input device, a circuitry, an acoustic model, a language model, a speech recognition engine, a machine translation engine, a speech synthesis engine, and a voice output device,
wherein the voice input device converts voice from a user into a digital signal,
wherein the circuitry is configured to:
analyze the digital signal using the speech recognition engine equipped with the acoustic model and the language model to convert it into text data;
translate the text data into a different language using the machine translation engine; and
convert the translated text data into voice using the speech synthesis engine, and
wherein the voice output device outputs the voice to the user in real time.

2. The communication support system according to claim 1,
wherein the circuitry is configured to remove background noise based on noise reduction technology.

3. The communication support system according to claim 1,
further comprising a voice database,
wherein the circuitry is configured to:
select one of a number of voice samples stored in the voice database as the voice based on a voice sample selection algorithm; and voice profiling; and
generate the voice adjusted to the user's prosody using the speech synthesis engine.

4. The communication support system according to claim 1,
wherein the circuitry is configured to translate the text data using context and cultural nuance as parameters using a statistical translation model and a neural network.

5. A communication support method using a communication support system, wherein the communication support system comprises a voice input device, an acoustic model, a language model, a speech recognition engine, a machine translation engine, a speech synthesis engine, and a voice output device,
the method comprising:
converting voice from a user into a digital signal by the voice input device;
analyzing the digital signal using the speech recognition engine equipped with the acoustic model and the language model to convert it into text data;
translating the text data into a different language using the machine translation engine;
converting the translated text data into voice using the speech synthesis engine; and
outputting the voice to the user in real time by the voice output device.
